(19) United States
(12) Patent Application Publication
(10) Pub. No.: US 2014/0190777 A1
(43) Pub. Date: Jul. 10, 2014

(54) BRAKE LININGS AND PROCESS OF MANUFACTURING THEREOF

(71) Applicant: DUROLINE S.A, CAXIAS DO SUL (BR)

(72) Inventor: Jacir DALLEGRAVE, CAXIAS DO SUL (BR)

(73) Assignee: DUROLINE S.A., CAXIAS DO SUL (BR)

(21) Appl. No.: 14/207,488

(22) Filed: Mar. 12, 2014

Related U.S. Application Data
(63) Continuation-in-part of application No. 13/326,299, filed on Dec. 14, 2011, now abandoned.
Application No. 13/326,299 is a continuation of application No. PCT/BR2010/000132, filed on Apr. 19, 2010.

(30) Foreign Application Priority Data
Jun. 19, 2009 (BR) PI 0903680-6

(51) Int. Cl. F16D 69/02; B29C 43/20; B02C 23/08; B29C 43/00

(52) U.S. Cl. CPC F16D 69/02; B29C 43/003; B29C 43/203; B02C 23/08
USPC 188/250 G; 264/37.3; 264/259; 264/319; 241/24.1

(57) ABSTRACT

The present invention discloses brake lining and process of manufacture thereof using a recycled friction material to form a multilayered brake lining with varying densities.

### CROSS-REFERENCE TO RELATED APPLICATIONS

This application is a CONTINUATION-IN-PART application claiming the benefit of priority of the co-pending U.S. Non-Provisional Utility patent application Ser. No. 13/326,299 with a filing date 14 Dec. 2011, which is a CONTINUATION application claimed the benefit of priority of the International Patent Application No. PCT/BR2010/000132 with an international filing date 19 Apr. 2010 that designated the United States, which claims the benefit of priority of Federal Republic of Brazil Application No. PI 0903680-6, filed 19 Jun. 2009, the entire disclosures of each (and all) of which applications are expressly incorporated by reference in their entirety herein. It should be noted that where a definition or use of a term in the incorporated patent applications is inconsistent or contrary to the definition of that term provided herein, the definition of that term provided herein applies and the definition of that term in the incorporated patent applications does not apply.

### BACKGROUND OF THE INVENTION

1. Field of the Invention

The present invention relates to braking linings used in drum brake systems and, more particularly, to braking linings and process of manufacture thereof used in drum brake systems for heavy vehicles such as buses, trucks, truck trailers, etc.

2. Description of Related Art

Conventional brake linings and conventional processes of manufacturing brake linings are well known and have been in use in well-known drum brake systems for a number of years. In general, most brake linings (especially for heavy vehicles such as large trucks) are attached to a brake shoe using rivets in well-known conventional manner.

The brake linings are frictional materials that include holes with countersinks and or counter-bore within a body of the brake lining that receive and secure a rivet head, with a rivet body attaching the brake lining to the brake shoe. The brake linings are generally replaced by auto mechanics when they are worn out, which is before a point where the brake lining reaches the rivet head (at or near the countersink and or counter-bore within the brake lining body) to thereby prevent the rivet from contacting a drum during braking. In general, the approximate amount of brake lining remaining after it is considered as worn out constitutes about a third (or about 30%) of the braking lining mass, which regrettably, is thrown out (or disposed or discarded) as waste.

Conventional brake linings of a drum brake system are generally comprised of friction material of uniform density throughout the brake lining. That is, the conventional brake linings are comprised of either a uniform high or a uniform low-density frictional material throughout the brake lining. Brake linings with a uniform high-density frictional material usually have a longer longevity but may increase the wear on the drums, reducing the longevity of the drums. Brake linings with a uniform lower-density frictional material usually have a lower longevity, causing the brake lining to wear out faster.

Accordingly, in light of the current state of the art and the drawbacks to current brake lining and process of manufacture thereof mentioned above, a need exists for an improved brake lining of a drum brake system that would be low cost to produce, would have higher longevity and superior brake quality. Further, a need exists for an improved process of manufacture of brake lining of a drum brake system that would recycle and use worn out, disposed or discarded brake linings for producing improved brake linings that are low cost, have higher longevity, and superior brake quality.

### BRIEF SUMMARY OF THE INVENTION

A non-limiting, exemplary aspect of an embodiment of the present invention provides a method for generating friction material to form a brake lining of a drum brake system, comprising a recycled friction material, a friction lining materials, and optionally a recycled fresh friction material, wherein: a recycled friction material composition is generated using the recycled friction material, the friction lining materials, and the optional recycled fresh friction material.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A and 1B are non-limiting, exemplary flowcharts that illustrate an exemplary instance of a flow process and equipment used in processing and recycling used, worn out brake lining (i.e., the used, worn out friction material) of a drum brake system, in accordance with one or more embodiments of the present invention;

FIG. 2 is non-limiting, exemplary flowchart that illustrates an exemplary instance of a process for composition and equipment for manufacturing brake lining for a drum brake system in accordance with one or more embodiments of the present invention;

FIGS. 3A-1 to 3A-4 are non-limiting, exemplary schematics of a first phase of a pre-form process cycle that progressively illustrate generating a first layer pre-form (or simply pre-form) of a multilayered pre-form of a brake lining of a drum brake system in accordance with one or more embodiments of the present invention;

FIGS. 3B-1 to 3C are non-limiting, exemplary schematics of a second phase of a pre-form process cycle that progressively illustrate generating a multilayered pre-form brake lining of a drum brake system that is used to produce a multilayered pre-form in accordance with one or more embodiments of the present invention;

FIG. 3D is a non-limiting, exemplary chart that graphs the pressure, temperature, and timing of the pre-form process cycle in accordance with one or more embodiments of the present invention;

FIGS. 4A to 4D are non-limiting, exemplary detailed illustrations of an exemplary pre-form press used in accordance with one or more embodiments of the present invention;

FIGS. 5A to 5E are non-limiting, exemplary illustrations of hot press cycle, with FIG. 5E illustrating an exemplary chart that graphs the pressure, temperature, and timing of the hot press cycle in accordance with one or more embodiments of the present invention;

FIG. 6 is a non-limiting, exemplary illustrative chart that graphs a heat treatment process in accordance with one or more embodiments of the present invention; and

FIGS. 7A to 7D are non-limiting, exemplary illustrations of a friction material in accordance with one or more embodiments of the present invention, with FIG. 7C as a non-limiting, exemplary illustration of a section view taken from FIG. 7A, and FIG. 7D as a non-limiting, exemplary illustration of a perspective view of FIG. 7A, emphasizing the variations in densities.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

Throughout the disclosure, references to a brake lining are referring to the friction material that are detachably associated with a brake shoe using fasteners such as rivets, which are used in drum brakes systems only.

One or more embodiments of the present invention provide a brake lining that is low cost, has higher longevity and with superior quality brake performance. Further, one or more embodiments of the present invention provide an improved process of manufacture of brake lining that recycle and use worn out (disposed or discarded) used brake lining to generate improved brake linings with low cost, higher longevity, and superior quality braking performance.

One or more embodiments of the present invention provide a brake lining that uses recycled friction material to thereby reduce the negative environmental impact by discarded worn out wasted brake linings while conserving natural resources and further, has a varying density that varies in at least one direction (e.g., transverse the principle loading direction) to improve brake quality and longevity.

One or more embodiments of the present invention provide a multilayered brake lining that uses a first layer of recycled friction material to thereby reduce the negative environmental impact by discarded worn out wasted brake linings while conserving natural resources and further, has a varying density that varies in at least one direction (e.g., transverse the principle loading direction) to improve brake quality and longevity.

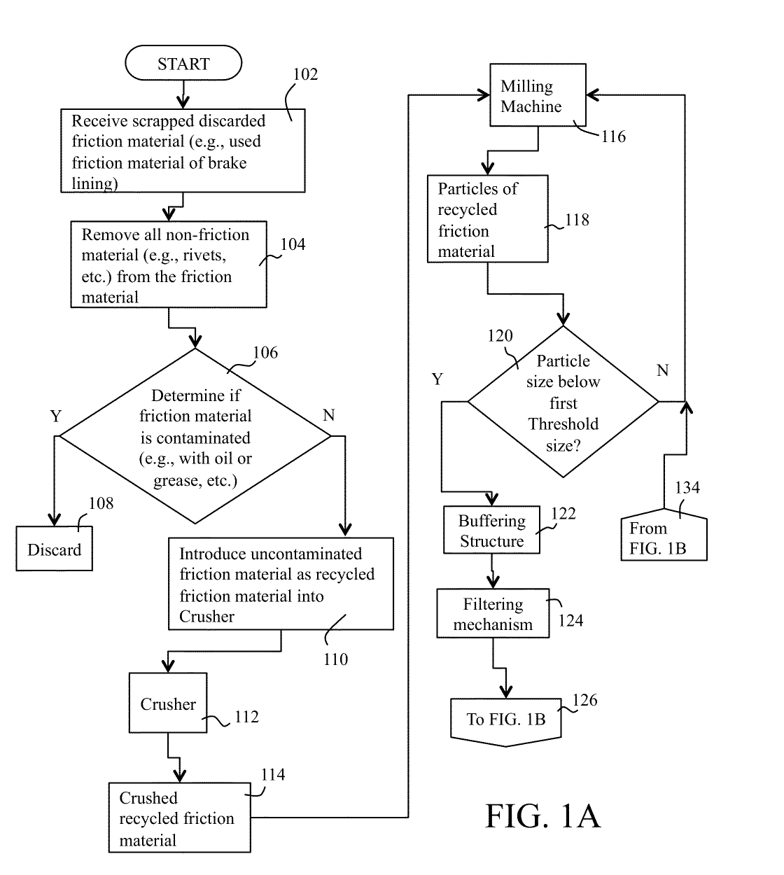

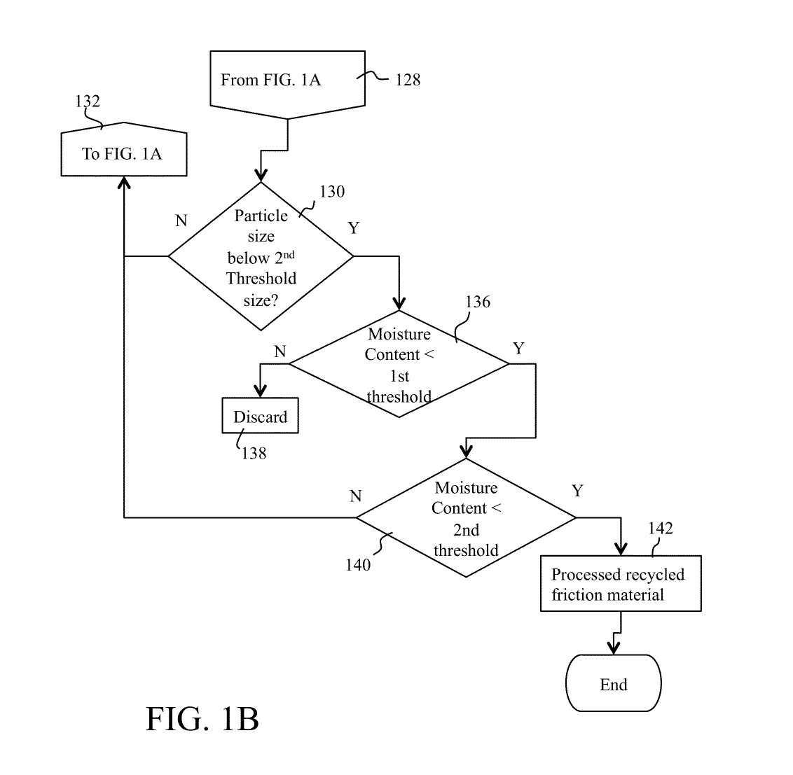

FIGS. 1A and 1B are non-limiting, exemplary flowcharts that illustrate an exemplary instance of a flow process and equipment used in processing and recycling used, worn out brake lining (i.e., the used, worn out friction material) of a drum brake system, in accordance with one or more embodiments of the present invention. As detailed below, at the end of the recycling process, the finally processed recycled friction material may be used to produce a brake lining in accordance with one or more embodiments the present invention.

Referring to FIG. 1A, the method for recycling brake linings of a drum brake system in accordance with one or more embodiments of the present invention commences at operation 102, where scrapped, discarded, and used friction material of brake linings are introduced into the recycling process. As part of the initial recycling process, all non-friction material (e.g., rivets, or other components, etc.) from the friction material is removed at operation 104. Thereafter, determination is made with respect to the contamination level of the remaining friction material at operation 106. That is, any friction material that is visibly contaminated (e.g., by oil or grease) or has high moisture content is discarded (at operation 108). Accordingly, in general, the recycling process in accordance with one or more embodiments of the present invention requires the use of used or worn out generally uncontaminated (at least visibly) friction material.

The used, worn out, generally uncontaminated friction material (or recycled friction material) is then transported and introduced into a crusher 112 at operation 110. The crusher 112 may comprise of any well known and conventional crusher, non-limiting example of which may include a jaw crusher. The crusher crumbles the recycled friction material to generate crushed recycled friction material of small pieces or crumbles at operation 114, which is transported to a milling machine 116. The milling machine 116 may comprise of any well known and conventional milling machine, non-limiting example of which may include the use of a well known hammer mill machine.

The milling machine 116 granulates the crushed recycled friction material to generate recycled friction material particles at operation 118. In generals, most milling machines include a filter with holes that sieves out larger sized particles or grains for continued granulation (or re-milling) while allowing particles or grains of smaller size to pass through. Once the particles or grains of recycled frictional material reach a size that is below a first threshold size, they pass through the filter holes for further processing. Accordingly, at operation 120, the filter of the milling machine 116 allows only particles or grains sizes smaller than the first threshold size to pass through for further processing, while the remaining larger grain sized particles (greater than the first threshold size) are sieved out and continue to be milled at operation 118. In general, it is preferred if the first threshold size of the recycled friction material particles is approximately 8 millimeters or less, most preferably approximately 6 millimeters or less.

The recycled friction material particles below the first threshold size are transported (via a vacuum process) to a buffering structure, which stores sufficient amounts thereof for continuous recycling operation. In other words, at operation 122, the recycling process includes buffering sufficient amounts of the recycled friction material particles to allow for uninterrupted and continuous operations (for maintaining continuous work-flow) in cases where any of the preceding operations are interrupted (e.g., the crusher and or the mill become non-operational). A non-limiting example of a buffering structure may be a silo. It should be noted that the present application may be practiced without the buffering operation 122 (without the use of storing of material for the purpose of buffering for continuous operation). In other words, the recycled friction material particles may be directly transported to a filter mechanism 124 (detailed below) instead. It is only for the efficient operation of the overall recycling system in accordance with one or more embodiments of the present invention that buffering operation 122 is used.

As further illustrated in FIG. 1A, the buffered recycled friction material particles are released at predetermined amounts (by simple gravity) from the buffering structure and into a filtering mechanism 124. A non-limiting example of a filtering mechanism 124 may include well-known conventional vibratory sieves that vibrate to separate out the larger particles from the desired size particles, with the larger particles recycled back to the milling machine 116 for further granulation. Accordingly, as detailed in FIGS. 1A and 1B, at operation 130 (with the flow of the operation illustrated by the off-page connector 126 in FIG. 1A associated with the off-page connector 128 in FIG. 1B), filtering mechanism 124 separates buffered recycled frictional material particles of size below a second threshold size for further processing, while allowing the remaining larger sized particles to recycle back to the milling machine 116 (with the flow of the operation illustrated by the off-page connector 132 in FIG. 1B associated with the off-page connector 134 in FIG. 1A).

In general, it is preferred that the second threshold size of recycled friction material particles be approximately 5 millimeters or less and preferably approximately 3 millimeters or less. It should be noted that while the use of larger particle or grain sizes greater than 3 or 4 millimeters are possible, they may however, reduce the overall quality of the final brake lining product and in fact, may become a major cause of and or contributor to a final, defective product during manufacturing. For example, during the final, “finishing” process of a brake lining (which is detailed below), generally, some frictional material may be chipped away or broken off. If larger sized particles or grains of recycled frictional material are used to produce the final brake lining product and are chipped away, the entire brake lining would be deemed defective as the loss of larger particle size would represent a loss of a larger chunk or area of the overall frictional material. If smaller sized particles (e.g., 3 millimeters or less) are used to produce the final brake lining product and are chipped away, the mass loss would be negligible, unnoticed, and not affect the overall quality, preserving the overall integrity of the brake lining. Another benefit for using smaller size particles (of preferably less than or equal to 3 millimeters) is that the recycled friction material particles with smaller sizes mix better (the mixing process is detailed below), and provide an overall smoother surface of the brake lining. As detailed below, other materials are used and mixed with the recycled friction material particles to form the final brake lining, most of which are powder like (e.g., fine dry particles) substances and hence, a finer and a more granulated particle or grain size of the recycled friction material particles will result in a more homogenized and a more uniform mixing (or distribution) of the recycled friction material particles with the rest of the mix. As a final benefit, using smaller size recycled friction material particles of about less than 3 millimeters results in increased surface area of each particle (when they are granulated to almost a powder by the milling machine 116), which form a better resin bonding with other materials (detailed below).

As further illustrated in FIG. 1B, at operation 130 the filtering mechanism 124 separates buffered recycled frictional material particles of size below a second threshold size and at operations 136 and 140, the recycled frictional material particles of desired size are stored in batches (within bags) and tested for moisture content using well known conventional moisture sensor devices such as moisture balance analyzers. Accordingly, in addition to particle size, moisture content is also tested. If the recycled friction material particles used have high moisture content, during the hot-compression process (detailed below), the moisture content within the final mix (detailed below) will evaporate, causing swellings of the outer surface on brake lining and or may create hollow cavities within the brake lining. Accordingly, it is preferred to have as little moisture content within the recycled material (and in fact, the final mix) as possible. Therefore, if at operation 136 it is determined that the moisture content from a sampled set of recycled frictional material particles from a batch is greater than a first threshold level (for example, greater than approximately 6% to 10% in weight (wt)), then that batch is discarded (operation 138). Otherwise, at operation 140, if it is determined that the sampling has a moisture content less than the first threshold level but greater than a second threshold level (for example, greater than 2% or 3% in wt), then the entire batch is recycled back to the milling machine 116 (with the flow of the operation illustrated by the off-page connector 132 in FIG. 1B associated with the off-page connector 134 in FIG. 1A). The benefit of recycling the batch back to the milling machine is that the recycled frictional material particles of the batch will be mixed with incoming potentially dryer material (from operation 114), reducing the overall moisture content of the batch. In general, it is preferred that the moisture content of the recycled friction material particles is less than 2% in wt. The phrase “X % in wt” indicates, for example that if the entire mix is 600 Kg, which include 25% recycled material (or about 150 Kg), then a 10% in wt moisture content would amount to about 15 Kg of water in the 150 Kg of recycled material.

As finally illustrated in FIG. 1B, if at operation 140 it is determined that the moisture content from a sampled set of recycled frictional material particles from a batch is less than the second threshold level (for example, moisture content of approximately 2% in mass or less), then that batch of recycled frictional material particles is stored at operation 142, ready for use in manufacturing friction material for brake lining.

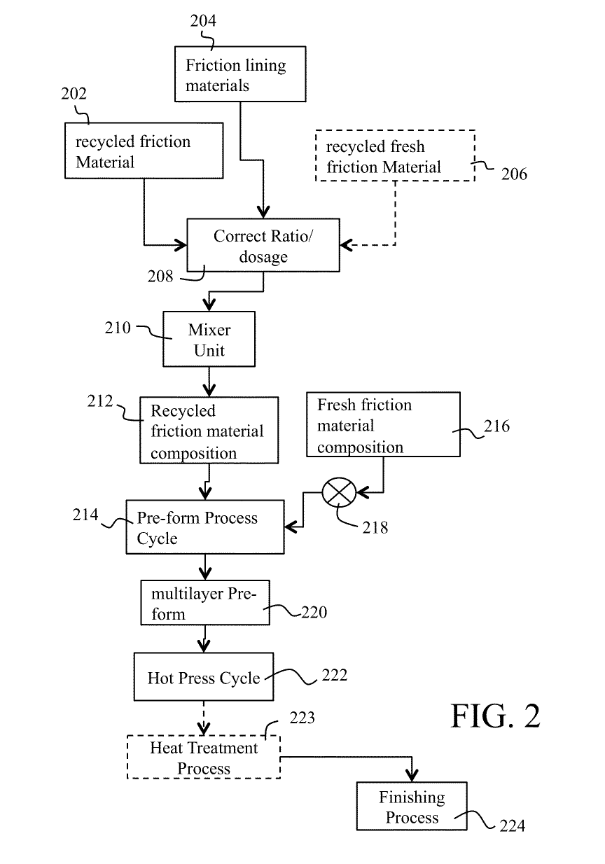

FIG. 2 is non-limiting, exemplary flowchart that illustrates an exemplary instance of a process for composition and equipment for manufacturing brake lining for a drum brake system in accordance with one or more embodiments of the present invention. The exemplarily illustrated process shown in FIG. 2 may be used to produce a single or multilayered friction material as brake lining of a drum brake system. However, the discussions that follow are generally directed to manufacturing multilayered friction material that uses the recycled friction material generated as disclosed above in relation to FIGS. 1A and 1B as generally (and preferably) a first layer of the multilayered friction material.

As illustrated in FIG. 2, the composition or formulation of a first layer of a multilayered brake lining (constituting the recycled friction material composition 212) includes the use of a predetermined amount of a recycled friction material 202 (produced by the processes disclosed in relation to FIGS. 1A and 1B), a predetermined amount of friction lining material 204 (detailed below), and a predetermined amount of a recycled fresh friction material 206.

The recycled fresh friction material 206 may be generally comprised of fresh friction material residue (or dust, powder, etc.) generated at a finishing process 224 (detailed below) of a final brake lining product that is comprised of original, non-recycled fresh friction material. Accordingly, even if a brake lining is produced by a completely conventional and well known processes with no recycled material by most manufactures, the present invention may recover, collect and reuse residue resulting from the finishing process 224 of a conventionally made brake lining comprised of non-recycled, original, fresh friction material. When producing brake lining that does not use any recycled material, during finishing process (which includes drilling, grinding, smoothing, etc.) friction material residue (or dust) is generated that may be recycled and used in accordance with the present invention. Additionally, in some instances, during the finishing process 224 the entire brake lining may be damaged (e.g., deep scratch) or break into pieces, which may be crushed, milled, and reused as the recycled fresh friction material 206. It should be noted that the recycled fresh friction material from the original brake lining finishing process must also meet similar moisture content and particle size requirements prior to use in the overall manufacturing process of the present invention. Correct particle size and moisture content requirements are easily met as the final brake line product at the finishing process of a fresh friction material already includes the correct particle size and moisture content and further, the finishing process of a fresh friction material generates particles of powder or dust, which have the appropriate size. Hence, in most cases, the “powder” or “dust” from the finishing process of the brake lining made from original material (non-recycled, fresh friction material) may directly be used without having to be milled. It should be further noted that it is preferred that the recycled residue of the fresh friction material from the finishing process to be minimal, which would indicate an efficient finishing process with little or no loss in the final product lining during the finishing process. However, the amount that is left (due to inefficiencies in the finishing process), that leftover residue or dust from the fresh friction material may be used in accordance with the present invention and recycled into a brake lining as the “recycled fresh friction material 206.”

Referring to FIG. 2, at operation 208, amounts of the recycled frictional material 202, the friction lining materials 204, and the recycled fresh friction material 206 (which is illustrated as dashed lines, indicating in this instance that it may be optional), are measured at correct ratios and or dosages (detailed in Tables 1 to 20) using well-known weighing and dosing processes and transported to a mixer unit 210.

The following Table 1 is a non-limiting, non-exhaustive listing of examples of materials (including non-limiting, non-exhaustive listing of examples of various combinations of materials) that may be used for formulation (or composition) of a first layer of friction material of a brake lining of a brake drum system in accordance with one or more embodiments of the present invention. Other materials not listed may also be used, depending on manufacturing requirements, non-limiting examples of which may include, for example, zinc powder, metal sulfides, etc. Accordingly, the number and types of materials, composition, combinations, and permutations thereof, including amounts thereof (e.g., in wt %) of any specific material used in any particular formulations (or mixtures) for the first layer of the brake lining in accordance with one or more embodiments of the present invention may vary and depends on many factors, including the overall quality of the friction material of braking lining desired. For example, the use of recycled friction material 202 and its maximum amount of 85 wt % in a particular formulation (that may include 3 wt % of fiberglass and 12 wt % of Phenolic Resin) for the first layer friction material of a brake lining would produce a functioning brake lining that may be appropriate for smaller or lighter weight vehicles, but would have a shorter longevity if used as brake lining of a larger vehicle such as a larger sized heavy trucks. As another example, the use of only 1 wt % recycled friction material may require the user of larger amounts of filler material, and so on. Accordingly, the specific materials and wt % of each material that constitute the final formulation of the first layer portion of the friction material of the brake lining in accordance with one or more embodiments of the present invention may vary and are commensurate with the type or quality of brake lining desired. It should be noted that the present invention defines wt % as a ratio of a substance with weight W_{S} to the weight of the total mixtures W_{TM} multiplied by 100, or (W_{S}/W_{TM})×100=wt %.

FORMULATION FOR FIRST LAYER

| | | | First | Second | Third | Fourth |
|---|---|---|---|---|---|---|
| | | Most | Non- | Non- | Non- | Non- |
| | Preferred | Preferred | Limiting | Limiting | Limiting | Limiting |
| | Ranges | Ranges | Example | Example | Example | Example |
| | (wt %) | (wt %) | (wt %) | (wt %) | (wt %) | (wt %) |
| Recycled | 1-85% | 10-30% | 25% | 10% | 30% | 20% |
| Friction | | | | | | |
| Material | | | | | | |
| Recycled | 0-70% | 0-30% | 25% | 25% | 20% | 15% |
| Fresh | | | | | | |
| Friction | | | | | | |
| Material | | | | | | |

Friction Lining Materials:

| | | | | | | |
|---|---|---|---|---|---|---|
| Clays and | 0-75% | 0-30% | 0% | 14% | 0% | 0% |
| fillers- | | | | Kaolin | | |
| Non- | | | | | | |
| Limiting | | | | | | |
| Examples: | | | | | | |
| Calcium | | | | | | |
| Carbonate | | | | | | |
| Barites | | | | | | |
| Kaolin | | | | | | |
| Silicates | 0-40% | 5-15% | 2% | 2% | 2% | 5% |
| metallic | | | Aluminum | Aluminum | Aluminum | Aluminum |
| oxides and | | | Oxide; | Oxide; | Oxide; | Oxide; |
| friction | | | 5% | 5% | 5% | 5% |
| enhancers- | | | Magnesium | Magnesium | Magnesium | Magnesium |
| Non-limiting | | | Oxide; | Oxide; | Oxide; | Oxide; |
| Examples: | | | 3% | 3% | 3% | 5% |
| Quartz | | | Quartz. | Quartz. | Quartz. | Quartz. |
| (SiO₂) | | | | | | |
| Aluminum | | | | | | |
| Oxide | | | | | | |
| (Al₂O₃) | | | | | | |
| Iron Oxide | | | | | | |
| (Fe₂O₃) | | | | | | |
| Magnesium | | | | | | |
| Oxide | | | | | | |
| (MgO) | | | | | | |
| Sulfur Oxide | | | | | | |
| (SO₃) | | | | | | |
| Calcium | | | | | | |
| Oxide (CaO) | | | | | | |
| Lime | 0-60% | 1-5% | 0% | 0% | 0% | 0% |
| Grounded | 0-60% | 5-15% | 10% | 10% | 10% | 8% |
| rubber | | | | | | |
| Coke- | 0-40% | 0-20% | 0% | 0% | 0% | 5% |
| Non- | | | | | | Metallurgical |
| Limiting | | | | | | |
| Examples: | | | | | | |
| Petro Coke | | | | | | |
| Metallurgical | | | | | | |
| Coke | | | | | | |
| Metallic | 0-40% | 0-10% | 0% | 0% | 0% | 5% |
| powders - | | | | | | (Brass |
| Non- | | | | | | chips) |
| Limiting | | | | | | |
| Examples: | | | | | | |
| Iron Pyrite | | | | | | |
| Iron powder | | | | | | |
| Zinc powder | | | | | | |
| Brass Chips | | | | | | |
| Cellulose | 0-10% | 1-3% | 2% | 2% | 2% | 2% |
| Fiberglass | 0-30% | 4-15% | 7% | 8% | 6% | 6% |
| Fibrous | 0-30% | 0-15% | 0% | 0% | 0% | 3% |
| materials - | | | | | | (Steel |
| Non- | | | | | | Fiber) |
| Limiting | | | | | | |
| Examples: | | | | | | |
| Rock wool | | | | | | |
| Glass wool | | | | | | |
| Wollastonite | | | | | | |
| Steel fiber | | | | | | |
| Acrylic fiber | | | | | | |
| Aramide | | | | | | |
| fiber | | | | | | |
| Ceramic | | | | | | |
| fiber | | | | | | |
| Graphite | 0-30% | 3-10% | 6% | 6% | 6% | 6% |
| Friction Dust | 0-30% | 0-5% | 0% | 0% | 0% | 0% |
| (Cashew | | | | | | |
| Powder) | | | | | | |
| Binding | 5-30% | 12-18% | 15% | 15% | 16% | 15% |
| resin- | | | | | | |
| Non- | | | | | | |
| Limiting | | | | | | |
| Examples: | | | | | | |
| (Phenolic | | | | | | |
| Resin) | | | | | | |

| | | | | |
|---|---|---|---|---|
| TOTALS | 100% | 100% | 100% | 100% |

The following tables 2 to 20 are non-limiting, non-exhaustive listing of examples of properties and non-limiting exemplary values for the properties that may be used for formulation (or composition) of a first layer of friction material of a brake lining of a brake drum system in accordance with one or more embodiments of the present invention.

TABLE 2
Recycled Friction Material
Generally Preferred Properties

Particle size approximately <3 mm to 5 mm
Moisture content approximately <2 wt %

TABLE 3
Recycled Fresh Friction Material
Generally Preferred Properties

Particle size approximately <3 mm to 5 mm
Moisture Content approximately <2 wt %

TABLE 4
Barites
Generally Preferred Properties

Density approximately <4.50 g/cm³
Apparent density approximately <2.5 g/cm³
Particle size approximately <0.045 mm
Moisture content approximately <2 wt %

TABLE 5
Calcium Carbonate
Generally Preferred Properties

Particle size approximately <0.045 mm
Moisture approximately <1 wt %

TABLE 6
Kaolin
Generally Preferred Properties

Apparent density about 0.700 g/cm3 (±0.25 g/cm3)
Moisture content approximately <2 wt %
Particle size approximately <0.074 mm

TABLE 7
Quartz
Generally Preferred Properties

Moisture approximately <0.75 wt %
Particle size approximately <0.044 mm
SiO₂ content approximately >97 wt %

TABLE 8
Aluminum Oxide
Generally Preferred Properties

Al₂O₃ content approximately >92.5 wt %
SiO₂ content approximately <2.5 wt %
Particle size approximately <0.025 mm

TABLE 9
Iron Oxide
Generally Preferred Properties

Density approximately 3.80 to 5.00 g/cm³
Particle size approximately <0.044 mm

TABLE 10
Magnesium Oxide
Generally Preferred Properties

MgO content approximately >94 wt %
CaO content approximately <2 wt %
SiO₂ content approximately <1.5 wt %
Fe₂O₃ content approximately <1.5 wt %
Al₂O₃ content approximately <1 wt %
Particle size approximately <0.21 mm

TABLE 11
Rubber Powder
Generally Preferred Properties

Volatile contaminations, e.g., grease, oil, etc.
approximately <2 wt %
Ash contaminations approximately <6 wt %
Particle size approximately <0.71 mm

TABLE 12
Metallurgical Coke
Generally Preferred Properties

Fix carbon approximately >85 wt %
Volatiles contaminations approximately <5 wt %)
Ash contaminations approximately <15.0 wt %
Sulfur content approximately <2.0 wt %
Moisture content approximately <2 wt %
Particle size approximately <0.368 mm

TABLE 13
Brass Chips
Generally Preferred Properties

Copper content approximately 45.00 wt % to 75.00 wt %
Zinc content approximately 25.00 wt % to 45.00 wt %
Density approximately 6.00 g/cm³ to 9.50 g/cm³
Particle size approximately <0.150 mm

TABLE 14
Cellulose
Generally Preferred Properties

Moisture content approximately <4.70 wt %
Particle size approximately between 1 mm to 5 mm

TABLE 15
Fiberglass
Generally Preferred Properties

Chopped Strands Length approximately 4 mm (+/−0.2 mm)
Moisture content approximately <0.10 wt %
Bulk density (ml/g) approximately 1.00 to 2.30

TABLE 16
Rock Wool
Generally Preferred Properties

Fiber length 0.075 mm to 0.175 millimeters
Shot size approximately >0.125 mm
Shot content approximately <5 wt %

TABLE 17
Glass Wool
Generally Preferred Properties

Moisture content approximately <1.5 wt %
Apparent density approximately 0.030 g/cm³ (±0.008 g/cm³)

TABLE 18
Wollastonite
Generally Preferred Properties

CaO approximately 35.00 to 55.00 wt %
SiO₂ approximately 40.00 to 60.00 wt %

TABLE 19
Graphite
Generally Preferred Properties

Carbon approximately >90 wt %
Ash approximately <10 wt %
Moisture content approximately <0.50 wt %
Particle size approximately <0.21 mm

TABLE 20
Phelonic Resin
Generally Preferred Properties

Flow at 125° approximately 38 mm to 50 mm
Cure at 154° C. approximately 30 sec to 55 sec
Hexamine content approximately 8.5 to 9.5 wt %
Particle size approximately <0.074 mm
Moisture content approximately <1 wt %

It should be noted that the above tables 1 to 20 are non-limiting examples of various formulations and compounds that may be used in the first layer. In general, the first layer of the brake lining in accordance with the present invention requires a greater mechanical strength to maintain its physical and mechanical connection (via rivets or other mechanical fasteners) with the underlying brake shoe, where as the second layer requires a high quality braking power. Accordingly, all of the non-limiting examples 1 to 4 of Table 1 include fiberglass and other fibrous materials, which very much contribute to the overall mechanical strength of the first layer. It should be noted that the recycled friction material used in the first layer already has fiberglass or other fibrous material and hence, as indicated in Table 1, the more recycled friction material used, the less fibrous material would be needed or required to meet the mechanical strength requirements as the recycled friction material already contain fibrous materials such as fiberglass. Further, it is most preferred that the first layer also include heat conducting material (such as magnesium oxide) so that the heat generated by the brake lining during brake is conducted to the brake shoe, increasing the longevity of the brake lining. The non-limiting example 1 of Table 1 is an example of a formulation with desired mechanical strength and high friction level, which provides sufficient friction to stop vehicles loaded with up to about 23,000 pounds per axle. The non-limiting example 2 of Table 1 is a formulation with desired mechanical strength and high friction level that would also provide sufficient friction to stop vehicles loaded with up to 23,000 pounds per axle. However, the non-limiting example 2 of Table 1 uses less recycled friction material and therefore, a larger amount of fiberglass or fibrous material (extra 1 wt %) and fillers (14 wt %) are used instead to increase mechanical strength. Fillers are cheap material and add bulk and volume to the brake lining. The non-limiting example 3 of Table 1 is a formulation with desired mechanical strength and high friction level that also provides sufficient friction to stop vehicles loaded with up to 23,000 pounds per axle. However, the non-limiting example 3 of Table 1 uses more recycled friction material (opposite of example 2 of Table 1), which means less need for use of fiberglass or fibrous materials and no need for fillers. Non-limiting example 4 of Table 1 is a formulation for extra mechanical strength and even higher friction level that should provide sufficient friction to stop vehicles loaded with up to 26,000 pounds per axle, using medium quantities of recycled friction materials.

Referring to FIG. 2, as indicated above, at operation 208 the various ingredients that would constitute the recycled frictional material composition 212 are measured at desired ratios and or dosages and transported to a well-known, conventional mixer unit 210. The mixing unit 210 combines or mixes the recycled friction material 202, the recycled fresh friction material 206 (if available), and the friction lining materials 204 to generate the recycled friction material composition (which is in powder like form with particle sizes less than or equal to about 3 millimeters).

The process of mixing is generally, and preferably performed in one or more stages, with a stage of one or more stages including mixing for a duration a percentage of a total wt % of the recycled friction material 202, the recycled fresh friction material 206, and the compounds of the friction lining material 204. The stage of the one or more stages may comprise of a first, a second, and a third stage as detailed below. It should be noted that the number(s) of stages are not limited to three and may vary, the duration of mixing may also vary, and the percentages of the materials used and the order in which the materials are introduced into the mixture in a stage may vary. The variations depend on the amount and type of material used. The use of stages for mixing enhances uniformity or homogeneity in the mixture of all the material mixed throughout the final recycled friction material composition 212. A single stage for mixing all materials may be used, but would require longer duration of mixing to achieve the appropriate uniform mixture. This would not be beneficial because the mixer unit 210 would be running at a much longer duration, wasting energy. As detailed below, the appropriate amounts of materials are loaded into the mixer unit 210 in the desired quantities by a conventional and commercially available weighting and loading system (operation 208) for raw materials. Assuming a non-limiting, exemplary three stage mixing process, the first stage of the one or more stages includes mixing for a first duration a first percentage of a total wt % of the recycled friction material 202, a first percentage of a total wt % of the recycled fresh friction material 206, and a first percentages of a total wt % of the compounds of the friction lining material 204. The following is a non-limiting, exemplary instance of materials used in the first stage in accordance with the non-limiting example 1 of Table 1:

Stage 1, Duration: 180 seconds:
25% of the total wt % of recycled friction material
100% of the total wt % of Cellulose fiber
100% of the total wt % of Aluminum oxide
70% of the total wt % of Phenolic resin
50% of the total wt % of Graphite
60% of the total wt % of Fiberglass,
100% of the total wt % of Rubber powder
100% of the total wt % of Magnesium Oxide
100% of the total wt % of Quartz
25% of the total wt % of recycled fresh friction material

Materials where 100% of the total wt % is used in the first stage require longer time of mixing to be uniformly mixed throughout the rest of the mixture and hence, the entire amount (100%) is loaded into a mixer at the very first stage.

The second stage of the one or more stages includes mixing for a second duration a second percentage of a total wt % of the recycled friction material 202, a second percentage of a total wt % of the recycled fresh friction material 206, a final percentage of a total wt % of the compounds of the first friction lining material 204. Continuing non-limiting, exemplary instance of materials used in accordance with the non-limiting example 1 of Table 1:

Stage 2, Duration: 180 seconds:
50% of the total wt % of recycled friction material
30% of the total wt % of Phenolic resin
50% of the total wt % of recycled fresh friction material
40% of the total wt % of Fiberglass
50% of the total wt % of Graphite.

The third stage of the one or more stages includes mixing for a third duration a third percentage of a total wt % of the recycled friction material 202 and a third percentage of a total wt % of the recycled fresh friction material 206. Continuing non-limiting, exemplary instance of materials used in accordance with the non-limiting example 1 of Table 1:

Stage 3, Duration: 440 seconds:
25% of the total wt % of recycled friction material
25% of the total wt % of recycled fresh friction material

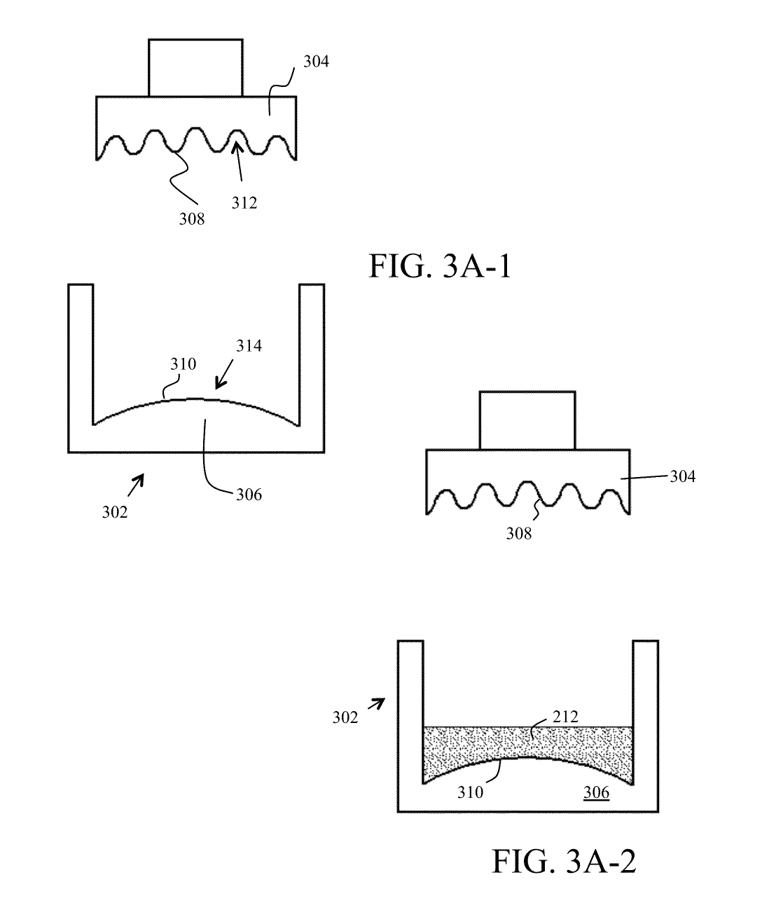

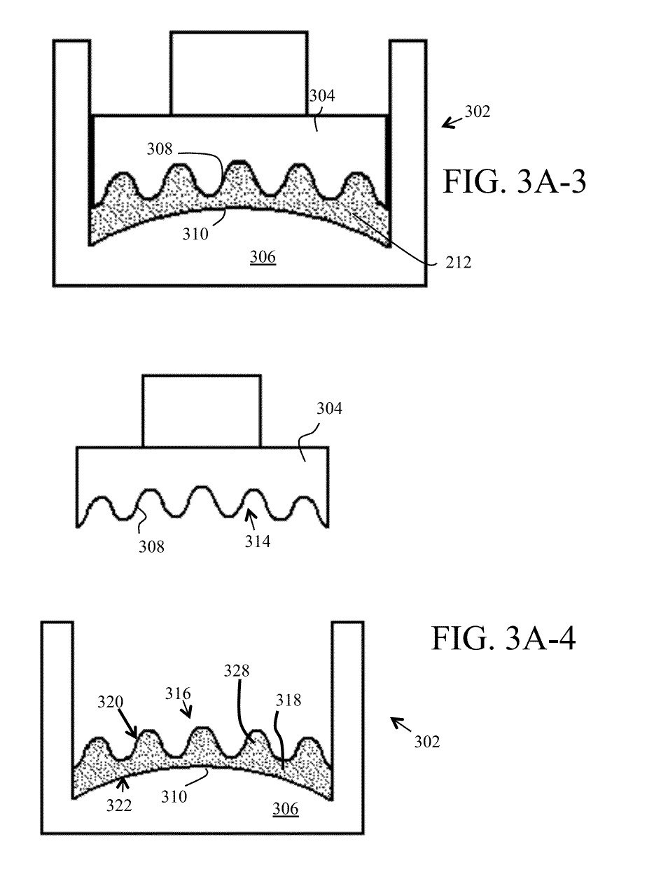

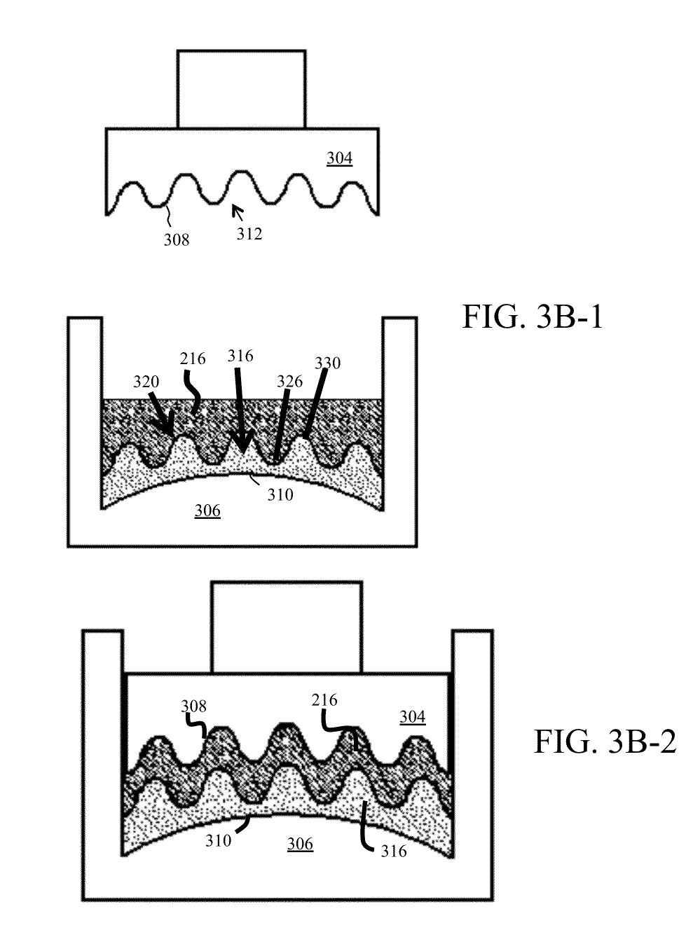

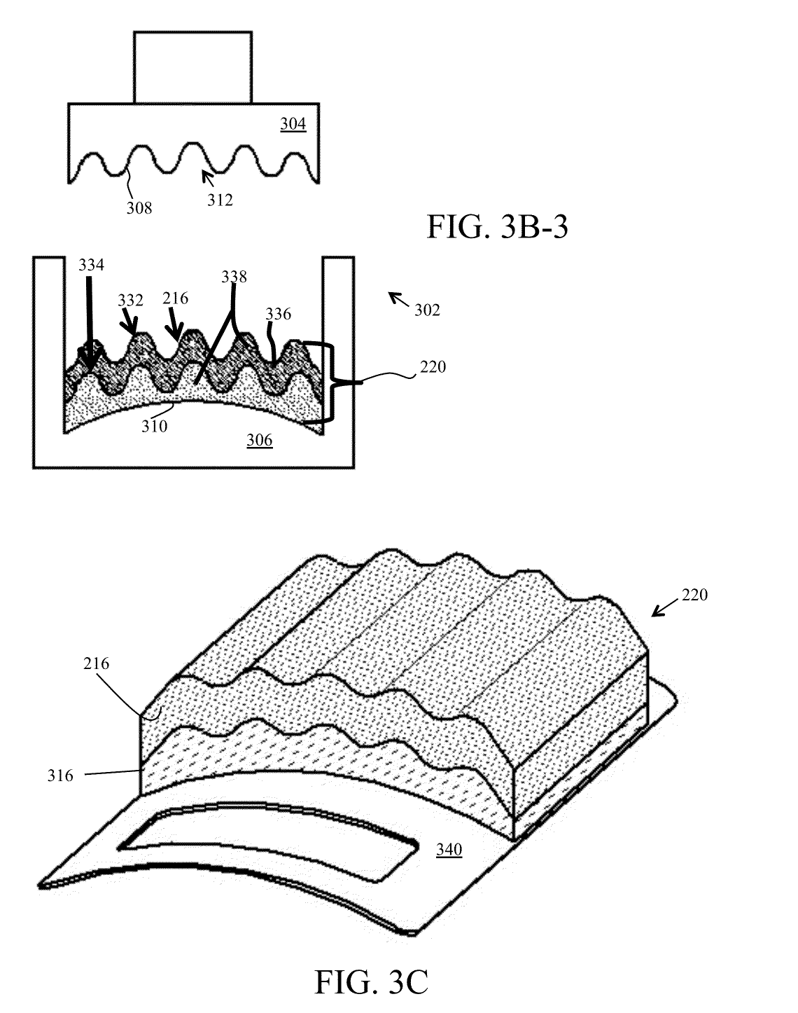

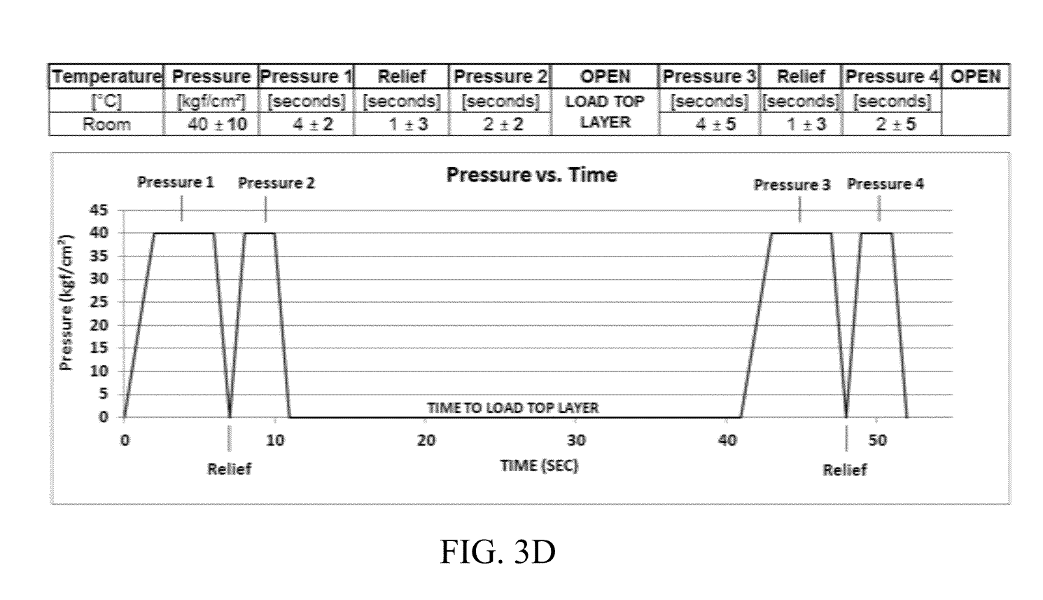

Referring to FIG. 2, the resulting recycled friction material composition 212 (at this stage of operation in a powder like form) is subjected to a pre-form process cycle at operation 214 where a predetermined amount of the recycled friction material composition 212 is shaped or molded into a pre-form using a pre-form press 302 (FIG. 3A-1), with the shape of the molded pre-form having varying quantities or amounts of materials distributed throughout the pre-form in accordance to the profile and surfaces of the pre-form press mold (detailed below). The details of the pre-form process cycle at operation 214 are described in relation to FIGS. 3A-1 to 4D.

FIGS. 3A-1 to 3A-4 are non-limiting, exemplary schematics of a first phase of a pre-form process cycle that progressively illustrate generating a first layer pre-form (or simply pre-form) of a multilayered pre-form of a brake lining of a drum brake system in accordance with one or more embodiments of the present invention. FIGS. 3B-1 to 3C are non-limiting, exemplary schematics of a second phase of a pre-form process cycle that progressively illustrate generating a multilayered pre-form brake lining of a drum brake system that is used to produce a multilayered pre-form in accordance with one or more embodiments of the present invention. FIG. 3D is a non-limiting, exemplary chart that graphs the pressure, temperature, and timing of the pre-form process cycle in accordance with the present invention.

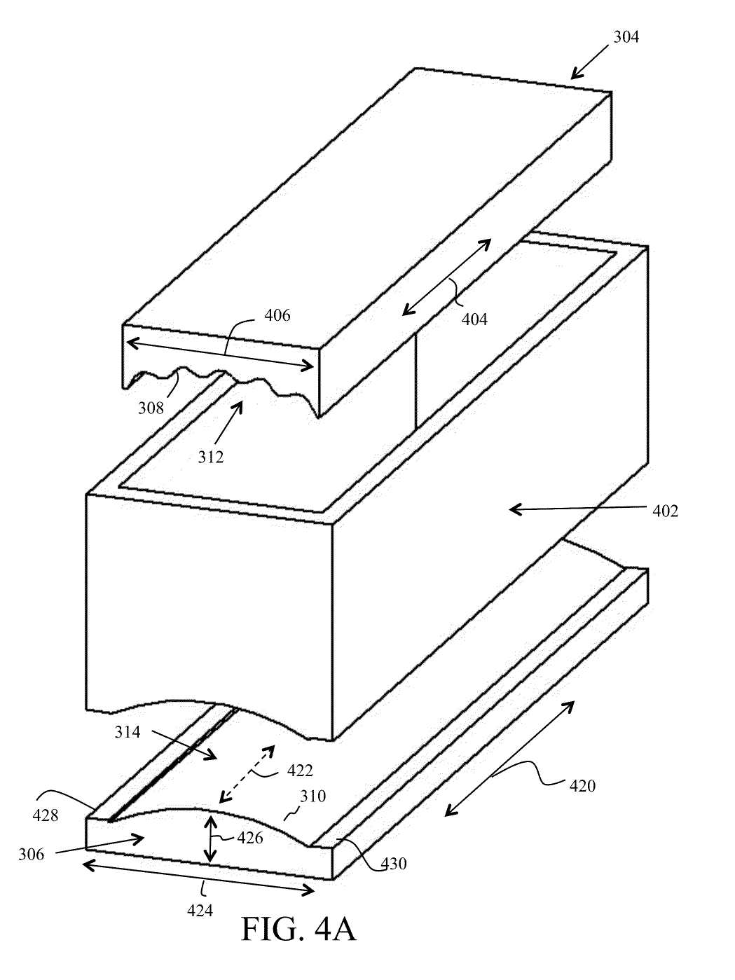

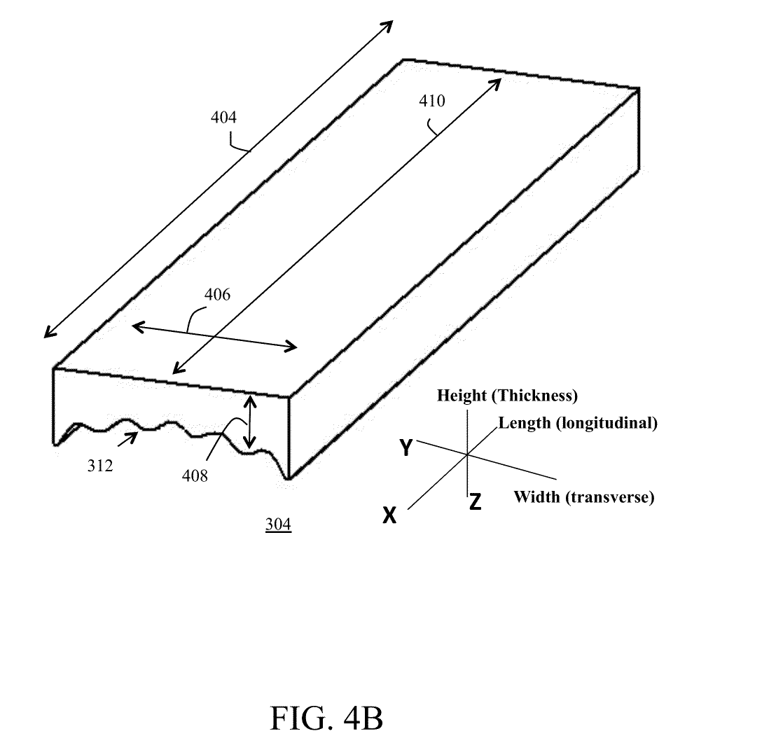

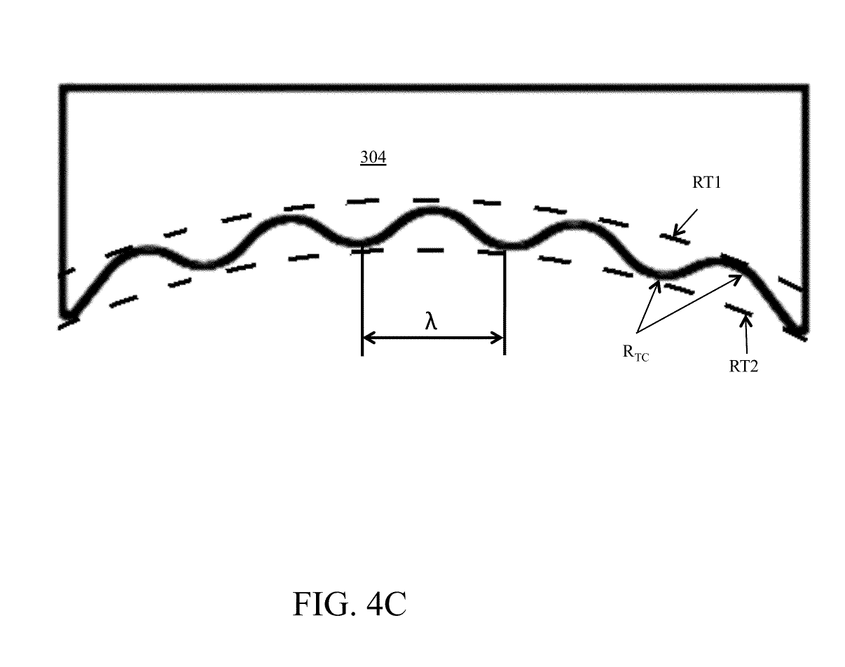

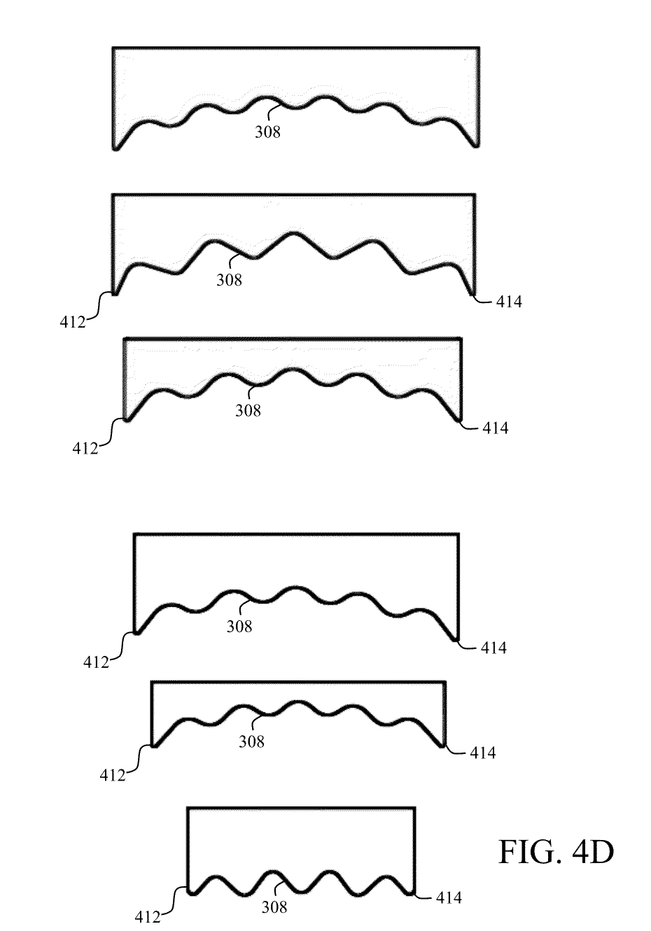

As illustrated in FIG. 3A-1 to 3A-4 for a first phase 322 (FIG. 3D) of pre-form process cycle, the operation 214 (FIG. 2) of the pre-form process cycle uses a pre-form press 302 (the details of which are discussed below in relation to FIGS. 4A to 4D) to pre-form a multilayered pre-form. The pre-form press 302 includes a first member 304 that is opened (FIG. 3A-1) for receipt of recycled friction material composition 212 (FIG. 3A-2) and has a first pressing side 312 with a first uneven surface 308 having a three-dimensional profile. The pre-form press 302 further includes a second member 306 that retains the recycled friction material composition 212 for compression, with the second member 306 having a second pressing side 314 with a second uneven surface 310 (in this non-limiting exemplary instance, a smooth convex curve, commensurate with brake shoe form).

As illustrated in FIGS. 3A-3 and 3A-4, the first uneven surface 308 faces the second uneven surface 310 to mold the recycled friction material composition 212 into a pre-form 316 (FIG. 3A-4) when the first member 304 closes (FIG. 3A-3) and presses against the second member 306 to thereby press the first uneven surface 308 of the first member 304 against the recycled friction material composition 212 from the top, with the second uneven surface 310 of the second member 306 pressing against the recycled friction material composition 212 from the bottom.

As best illustrated in FIG. 3A-4, the resulting pre-form 316 includes an upper surface 320 of a first shape (in this non-limiting, exemplary instance, undulating) and a lower surface 322 of a second shape (in this non-limiting, exemplary instance, a substantially smooth convex form), with the pre-form 316 having varying quantities or amounts of materials distributed throughout that includes higher quantity material regions 328 and lower quantity material regions 318 due to compression experienced from uneven first and second surfaces 308 and 310.

Referring to FIG. 3D, the first phase 322 of a pre-form process cycle is to generate the pre-form 316 from the recycled friction material composition 212 and as illustrated, the present invention uses a non-limiting two-cycle process to complete the first phase 322 for friction material defined by the non-limiting Example 1 of Table 1. However, any number and frequency of compression/relieve operations (or cycles), including amounts of pressure exerted may be used depending on the amount and type of material used to form the pre-form 316. The first phase 322 of the pre-form press cycle includes introducing the recycled friction material composition 212 inside the pre-form press 302 (FIG. 3A-2), and compressing (FIG. 3A-3) the recycled friction material composition 212 at a first pressure (for example about 40 kg/cm² (+/−10 kg/cm²)) for a first duration (for example about 4 sec (+/−2 sec)), and then relieving compression (FIG. 3A-2) for a second duration (for example about 1 sec (+/−3 sec)). This completes the first cycled of the first phase 322. Thereafter, compressing (FIG. 3A-3) the recycled friction material composition 212 at a second pressure (for example about 40 kg/cm² (+/−10 kg/cm²)) for a third duration (for example about 2 sec (+/−2 sec)), and relieving the compression (FIG. 3A-4). This completes the second, and final cycled of the first phase 322, which generates the pre-form 316.

It should be noted that if only a single layer of brake lining is required, then the pre-form press cycle operation 214 is complete at this stage and the next operation 222 (FIG. 2) of hot press cycle is performed. However, as indicated above, the one or more embodiments of the present invention provide for manufacturing multilayered friction material that uses the recycled friction material generated as disclosed above in relation to FIGS. 1A and 1B as generally (and preferably) as only a first layer of the multilayered friction material. Accordingly, as indicated in FIG. 2 and FIGS. 3B-1 to 3B-3, after generating a pre-form 316 (FIG. 3A-4), the present invention provides a pre-form process cycle operation 214 that has a second phase 324 that further includes adding (operation 218) a predetermined amount of fresh friction material composition 216 to the pre-formed recycled friction material composition 316, and pre-forming the combination of recycled and fresh friction material compositions to a multilayered pre-form 220, with a shape of the multilayered pre-form 220 having varying quantities or amounts of materials distributed throughout the multilayered pre-form 220. It should be noted that fresh friction material composition 216 (and its variations and use) are well known and conventional.

As indicated above, FIGS. 3B-1 to 3B-3 are non-limiting, exemplary schematics of a second phase 324 (FIG. 3D) of a pre-form process cycle that progressively illustrate generating a multilayered pre-form brake lining of a drum brake system that is used to produce a multilayered pre-form in accordance with one or more embodiments of the present invention. After completing the first phase 322, the pre-form press 302 that now includes the pre-form 316 is opened (FIG. 3B-1) for receipt of fresh friction material composition 216. As illustrated, the fresh friction material composition 216 occupies or fills-in the troughs (or recesses 326 of the uneven upper surface 320 of a first shape) of the pre-form 316, and is further added to fully cover the underlying pre-form 316 (passed the crests (or protuberances 330) of the uneven upper surface 320).

As illustrated in FIGS. 3B-2 and 3B-3, the first member 304 closes and presses against the second member 306 to thereby press the first uneven surface 308 of the first member 304 against the combination of pre-from 316 and fresh friction material compositions 216 to form a multilayered pre-form 220 (FIG. 3B-2), with the multilayered pre-form 220 having varying quantities or amounts of materials distributed throughout. As with the first layer (or pre-form 316), the top layer of the multilayered pre-form 220 (that comprises the fresh friction material composition 216 includes an upper surface 332 of a first shape (in this non-limiting, exemplary instance, undulating) and a lower surface 334 of a second shape (in this non-limiting, exemplary instance, undulating), with the multilayered pre-form 220 having varying quantities or amounts of materials distributed throughout that includes higher quantity material regions 338 and lower quantity regions 336 due to compression experienced from uneven first and second surfaces 308 and 310 of the pre-form press (i.e., molded in accordance to the profile of the pre-form press).

Referring back to FIG. 3D, the second phase 324 of a pre-form process cycle operation 214 is to generate the multilayered pre-form 220 and as illustrated, the present invention uses a non-limiting two-cycle process to complete the second phase 324 for friction material defined by the non-limiting Example 1 of Table 1. However, as with the first phase 322, this second phase 324 may vary and have any number and frequency of compression/relieve operations (or cycles), including varying amounts of pressure that are exerted that may be used depending on the amount and type of material used to form the multilayered pre-form 220. The second phase 324 of the pre-form press cycle includes introducing the fresh friction material composition 216 inside the pre-form press 302 (FIG. 3B-1) on top of the pre-form 316. Next, compressing (FIG. 2B-2) the combined recycled friction material composition and the fresh friction material composition at a third pressure (for example about 40 kg/cm² (+/−10 kg/cm²)) for a fourth duration (for example about 4 sec (+/−5 sec)), and then relieving (FIG. 3B-3) the compression for fifth duration (for example about 1 sec (+/−3 sec)). This completes the first cycle of the second phase 324. Thereafter, compressing (FIG. 3B-2) the combined recycled friction material composition and the fresh friction material composition at a fourth pressure (for example about 40 kg/cm² (+/−10 kg/cm²)) for a sixth duration (for example about 2 sec (+/−5 sec)), wherein a multilayered pre-form 220 is generated as best illustrated in FIG. 3C. It should be noted that the entire pre-form process cycle operations 214 is conducted under non-limiting ambient (e.g., room) temperature (other temperatures may be used).

As best illustrated in FIG. 3C, the final multilayered pre-form 220 (compacted powder form) in addition to having varying quantities or amounts of materials distributed throughout due to uneven surfaces 308 and 310 of the first and second member 304 and 306 also has uneven surfaces (having three-dimensional profile) for the top surface 320 of the first (or lower) layer 316 and the bottom surface 334 of the second (or upper) layer 216 that compressively mate or “interlock” and provide resistance or a resistive force against shear stresses experienced by the final brake lining product, which are generated during braking process. In other words, the pre-form 316 includes at least one uneven surface 320 that mates with an inner surface 334 of the added fresh friction material composition 216, with the inner surface 334 forming a shape that is complementary to the uneven surface 320 to facilitate mechanical resistance against shearing stresses experienced by the multilayer pre-form during braking process.

FIGS. 4A to 4D are non-limiting, exemplary detailed illustrations of an exemplary pre-form press used in accordance with one or more embodiments of the present invention. As indicated above, the pre-form press 302 includes a first member 304 that has a first axial length 404 (FIGS. 4A and 4B) that is parallel a first central longitudinal axis 410 of the first member 304, and a first transverse width 406 that is perpendicular to the first central longitudinal axis 410. The first member 304 of the pre-form press 302 further includes a first cross-section profile (a three-dimensional profile surface—non-limiting example of which is illustrated as undulations) with a varying first height 408 (FIGS. 4B and 4C) defining a first pressing side 312 with a first uneven surface 308 along the first transverse width 406, or the first axial length 404, or both the first transverse width 406 and the first axial length 404. In other words, the unevenness (the three-dimensional profile) of the first uneven surface 308 may be asymmetrical with respect to the central longitudinal axis 410, the axial length 404, and the transverse width 406. Alternatively, the unevenness (three-dimensional profile) of the first uneven surface 308 may be symmetrical with respect the central longitudinal axis 410. Alternately, the first uneven surface 308 may commence at a first end 412 of the transverse width 406, varies along the transverse width 406, and end at a second end 414 of the transverse width 406, with variations having undulating forms (as best illustrated in FIG. 4D).

Although the first uneven surface 308 may have any varied (random or patterned) shapes (no wave, with sharp edges, etc.), since the pre-form press molds powder like materials, smooth, undulating formats are preferred so that the powder particles do not adhere to its surfaces or sharp-edge walls (if non-undulating forms are used). Further, if the undulation is too steep (has a sharper slope, which produces a pre-form with sharper crests with longer amplitudes), during hot-press cycle operation 222 (detailed below), the molded sharper crests of the pre-form may develop cracks under the strong compression pressure of the hot-press plates. Cracks may develop due to insufficient material filling in the extra spaces (at the now deeper troughs of the waves) created by the longer amplitudes of the crests. On the other hand, if the undulation is too shallow (too gradual) and not sufficiently steep, their low depth or profile would not be sufficient to produce the compressively “interlocking” mating surfaces of the layers mentioned above and therefore, would provide very low resistance or a low resistive force against shear stresses experienced by the final brake lining product that may tear or shear the brake lining.

FIG. 4D includes a set of non-limiting, exemplary instances of different profiles of the first member 304 with varying first uneven surfaces 308, with all using wave forms with different amplitudes, wavelengths, crest and trough radius, etc. As best illustrated in FIG. 4C, in the non-limiting exemplary instance, the wavelength λ is about 30 to 40 millimeters, the amplitude is about 3 to 5 millimeters, and the radius of the crest and trough (R_{TC}) is about 8 to 15 millimeters. The upper and lower virtual radial tangent lines RT1 and RT2 to the apexes of the curves have a radius of about 226 mm to about 234 mm for the upper (RT1), and about 216 mm to about 224 mm for the lower (RT2) radial tangent line. It should be noted that the specific measurements provided with respect to the pre-from press 302 in FIG. 4C are non-limiting examples, which may vary depending on the size of lining, brake drum, and etc.

Referring back to FIG. 4A, the pre-form press 302 further includes a body portion 402 with appropriate dimensions to retain the powder like materials before, during, and after pressing. As further illustrated and indicated above, the pre-form press 302 also includes a second member 306 that has a second axial length 420 that is parallel a second central longitudinal axis 422, and a second transverse width 424 that is perpendicular to the second central longitudinal axis 422. The second member 306 further includes a second cross-section profile defining a varying second height 426, which defines the second pressing side 314 that has a second uneven surface 310 along the second transverse width 424, or the second axial length 420, or both the second transverse width 424 and the second axial length 420. In other words, the unevenness (the three-dimensional profile) of the second uneven surface 310 may be asymmetrical with respect to the second central longitudinal axis 422, the second axial length 420, and the second transverse width 422. Alternatively, the unevenness (three-dimensional profile) of the second uneven surface 310 may be symmetrical with respect the second central longitudinal axis 422. Alternately, the second uneven surface 310 may commence at a first end 428 of the second transverse width 422, vary along the second transverse width 422, and end at a second end 430 of the second transverse width 422, with variations having different forms.

Although the second uneven surface 310 may have any varied (random or patterned) shapes (without a smooth convex shape as illustrated), since the bottom surface of the pre-form 316 is simply attached to a brake shoe of a brake lining of a drum brake system with the similar form-factor, it is preferred that the second uneven surface 310 (if forming the bottom surface of the final friction lining) to have a configuration compatible with the brake shoe. However, both the first and the second member 304 and 306 may have varied (random or patterned) shapes. It should be obvious that the convex surface 310 will generate a concave bottom surface of the first layer.

As further illustrated, the first uneven surface 308 faces the second uneven surface 310, which when operational, mold the pre-form to a desired shape. It should be noted that reducing the profile size (shortening it along the transverse widths 406 and 424) of the pre-form press 302, will generate a shorter length friction material of a brake lining, which may be used for smaller compact vehicles. According, the width of the pre-form press 302 molds the length of the friction material brake lining. Therefore, reducing or increasing the width of the pre-form press 302, would vary the mold along the length of the friction material brake lining. Further, the first axial length 404 of the first member 304 and the second axial length 420 of the second member 304 are of sufficient span to generate an elongated multilayer pre-form 220 that may be cut into desired size, speeding the production of brake linings. As indicated above and best illustrated in FIG. 3C, the end product of the pre-form press processing cycle is a multilayered pre-form 220 that is compacted powder, which if touched, may crumble and hence, the pre-form press 302 further includes a carrier (or tray) 340 (FIG. 3C) that has a cross-sectional profile that is substantially compatible with the second cross-section profile of the second member, with the bottom surface of the carrier 340 resting on top surface 310 of the second member 306 during operation 220.

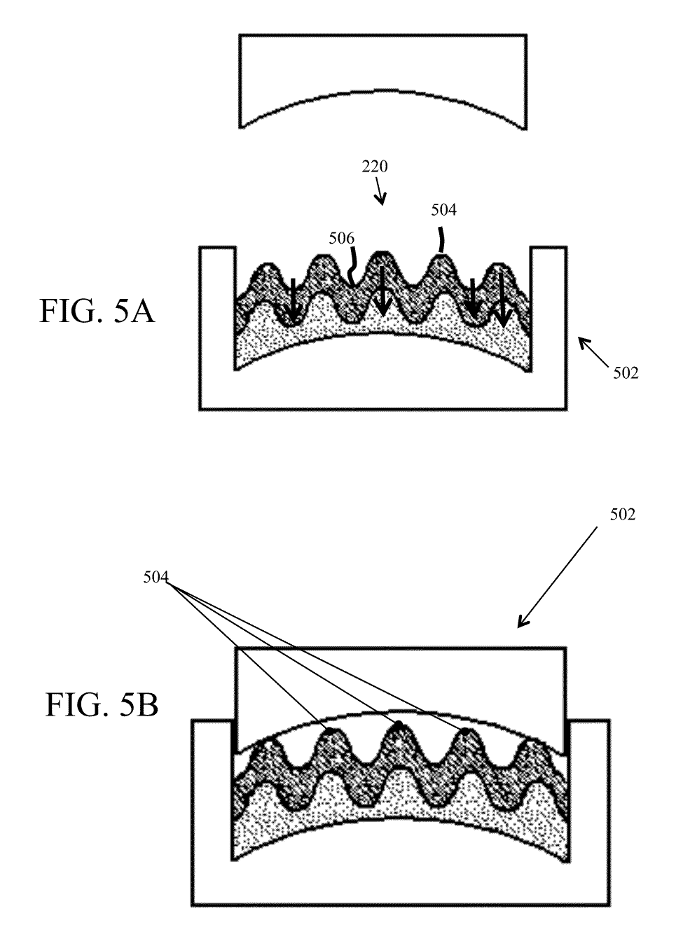

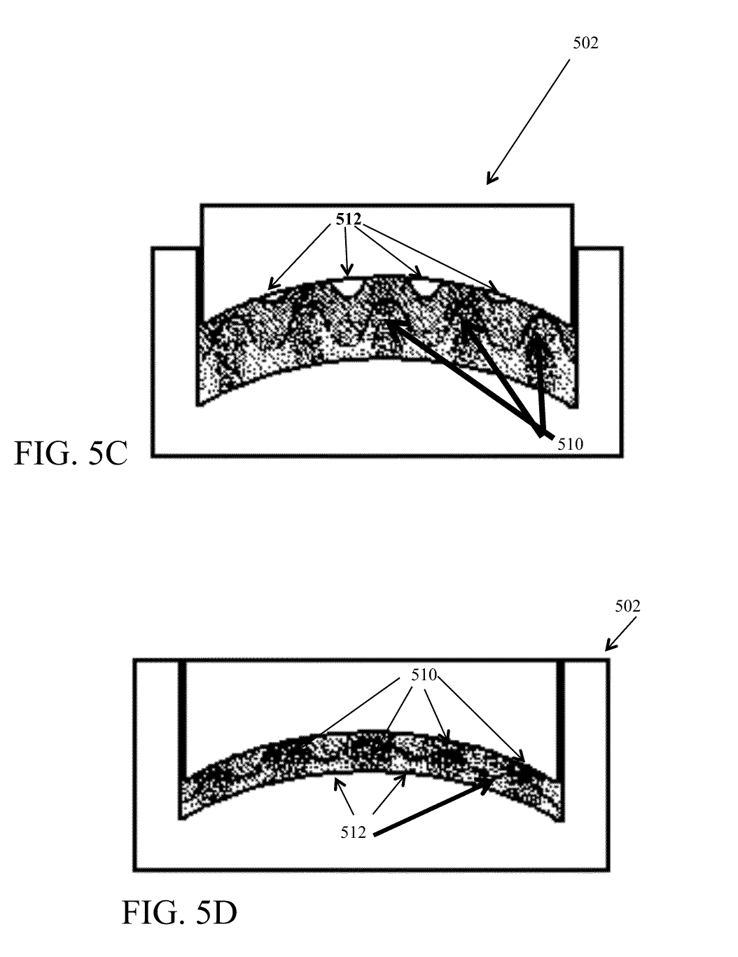

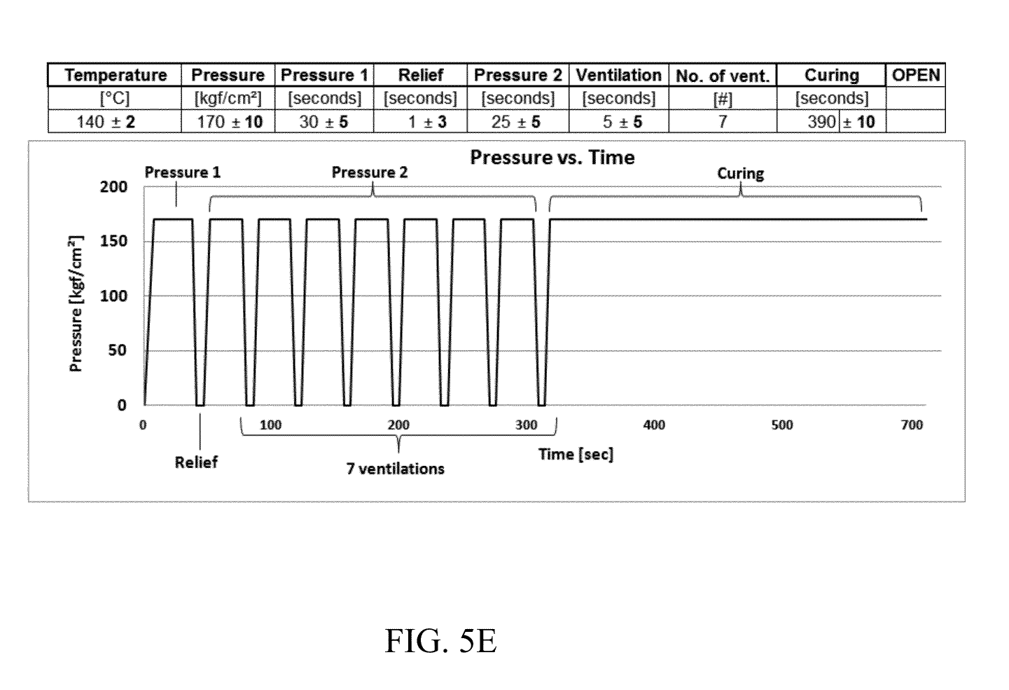

Referring back to FIG. 2, the resulting multilayered pre-form 220 (at this stage of operation in a compactly shaped or molded powder like form on the carrier 340) is subjected to a hot press cycle at operation 222. FIGS. 5A to 5E are non-limiting, exemplary illustrations of hot press cycle at operation 222, with FIG. 5E illustrating an exemplary chart that graphs the pressure, temperature, and timing of the hot press cycle in accordance with the present invention. It should further be noted that pressure, temperature, and durations of the hot press process cycle at operation 222 detailed below may be varied and change depending on the formulations (or mixtures) of materials used in particular, for the second (or upper) layer of the multilayered pre-form 220 that includes the fresh friction material composition 216. Accordingly, the hot press process cycle at operation 222 may vary and have any number and frequency of compression/relieve/temperature/duration operations (or cycles). In general, hot pressing the multilayered pre-form 220 molds the pre-form 220 to the final shape (prior to finishing process) of the brake lining product and will induce curing of the phenol resin. The hot pressing of the multilayered pre-form 220 will also produce a recycled brake lining with varied densities in at least one direct (e.g., perpendicular the principle loading direction) in accordance with the present invention. FIGS. 5A to 5D are non-limiting, exemplary illustrations that progressively illustrate the hot compression of the multilayered pre-form 220, including the generation of the varying densities thereof. The hot press machine 502 (illustrated in FIGS. 5A to 5D) used is well-known and conventional and hence, no further discussions with respect to the actual machine 502 itself, which is used for the hot press cycle operation 222 is required. As best illustrated in FIGS. 5A to 5D and charted in FIG. 5E, the hot press cycle at operations 222 include, introducing the multilayered pre-form 220 into the hot press 502 (FIG. 5A), and compressing (progressively illustrated in FIGS. 5B to 5D) the multilayered pre-form 220 at a pressure (for example, in this non-limiting instance, about 170 kg/cm² (−/+10 kg/cm²)) for a first duration (for example, in this non-limiting instance, about 30 sec (+/−5 sec)) at a temperature (for example, in this non-limiting instance, about 140° C. degrees), and relieving compression (FIG. 5A) for a second duration (for example, in this non-limiting instance, about 1 sec (+/−3 sec)). Thereafter, compressing the multilayered pre-form 220 at the same pressure, duration, and temperature, and relieving the compression. Next, compressing and relieving compression of the multilayered pre-form 220 at several intervals (compression at about 25 sec and relieving at about 5 sec (+/−5 sec)) at the same pressure and temperature (and repeating the same, depending on thickness of the multilayered pre-form and the type of material used in the upper or second layer). Finally, compressing the multilayered pre-form 220 at the same pressure and temperature, but for a second duration (for example, in this non-limiting instance, about 390 sec (+/−10 sec)).

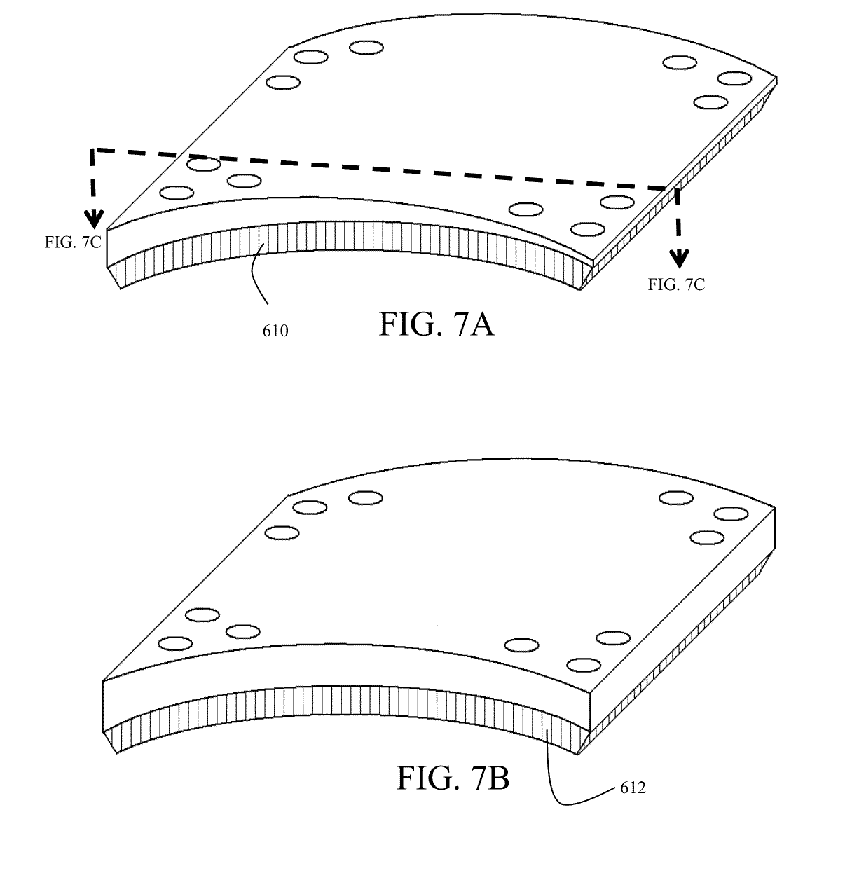

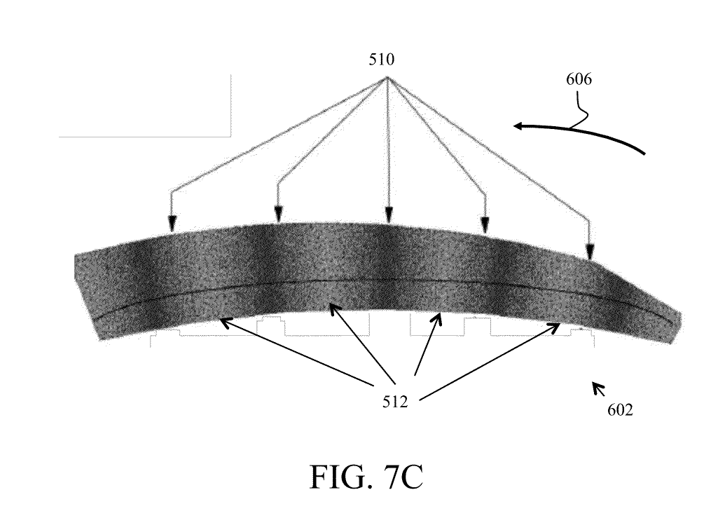

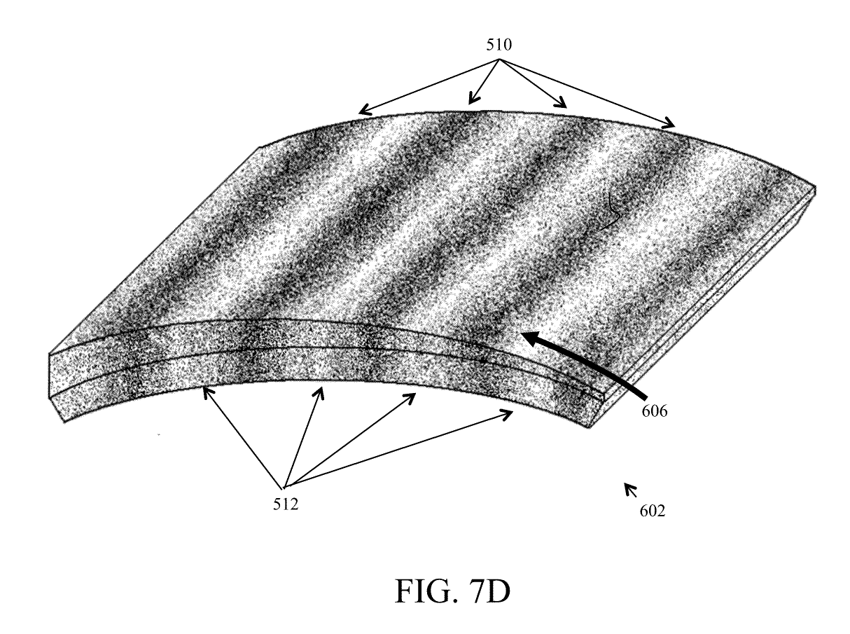

It should be noted that the crests 504 of the multilayered pre-form 220 when processed through the hot press operation 220 form the highest density regions 510 of the final brake lining product 602 and the troughs 506 from the lower density regions 512 (best illustrated in FIGS. 7C and 7D). In other words, the final brake lining product 602 as best illustrated in FIGS. 7C and 7D has a varying density that varies in at least one direction to improve brake quality and longevity. A non-limiting, exemplary profile view and a non-limiting exemplary perspective view of the brake lining product emphasizing the variations in densities are illustrated in the respective FIGS. 7C and 7D. In general, higher density regions 510 are more resistive against abrasion, increasing an overall longevity of the brake lining, and lower density regions 512 thereof have higher coefficient of friction for an overall improved brake quality. Further, the higher density regions 510 impede the process of abrasion of the lower density regions 512. That is, the higher density regions 510 of the brake lining impede (or slow) the wear of lower density regions 512 and protect the lower density regions 512 from further abrasion (due to variations in densities being transverse the principle loading direction 606) until the higher density regions 510 are worn out to or below a level of the lower density regions 512. In other words, the lower density regions 512 of the brake lining 602 are prevented from further abrasion until the higher density regions 510 are worn out to or below the lower density regions 512 levels and hence, improving brake quality while increasing longevity.

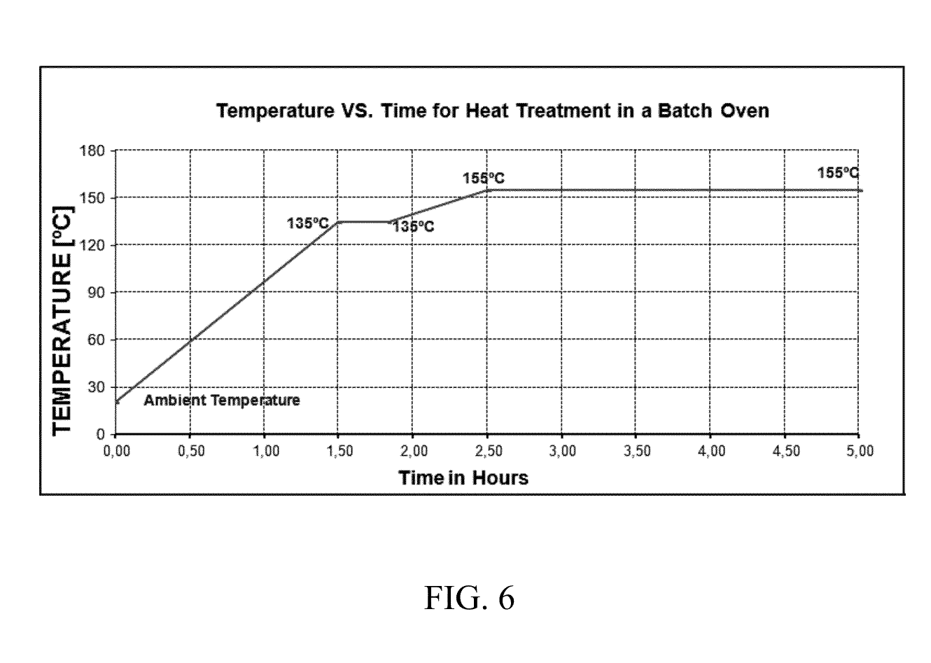

Referring back to FIG. 2, the resulting multilayered brake lining product 602 exemplarily and schematically illustrated in FIGS. 7A to 7D may optionally (preferred) be subjected to a heat treatment process at operation 223 (FIG. 2) in conventional ovens to ensure better curing of the resin and further, prevent further expansion of the brake lining due to heat of the lining during a braking process. The heat treatment process at operation 223 is a standard practice in the industry. As best illustrated in FIG. 6, the operation 223 subjects the brake lining product 602 to temperatures of about 135° C. to 155° C. or so for some predetermined times (usually from about 4 to 20 hours), with the gradual increase in temperate over time. It should be noted that if duration of the hot press cycle at operation 222 is long, then the heat treatment process at operation 223 may be optional.

Referring back to FIG. 2, the resulting multilayered brake lining product 602 exemplarily and schematically illustrated in FIG. 7A to 7D is subjected to Finishing Process at operation 224, where the brake lining 602 is machined with well known mechanical equipment and tools (drillers and grinders) to appropriate dimensions, including addition of holes for rivets as best illustrated in FIGS. 7A and 7B. It should be noted that the preferred size of the first or bottom layer is about 30 to 42% of the entire size of the brake lining 602. As illustrated, it is most preferred if the first or bottom layer is below the rivet heads. Depending on the hot press type used, in a tapered brake lining (FIG. 7A), the bottom layer 610 forms approximately 42% of the whole piece. In a non-tapered brake lining (FIG. 7B), the bottom layer 612 forms approximately 30% to the whole piece.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, for the pre-form compress cycle, the multilayered pre-form 220 of the present invention should not be limited to only dual layers, but multiple layers of the first layer may be formed, and then combined with multiple layers of the second layer to form a multilayered pre-form with more than two layers. In fact, any combinations or permutations of materials, cycles, phases, or layering may be used however, to do so, the “contacting” surfaces must be arranged so to compressively mate and “interlock” to prevent shearing and further, although it is possible to have different intervals of different layer formulations (e.g., layer 1 composition (molded), then on top of layer 1 adding layer 2 composition, then on top of the combined layers 1 and 2 compositions (molded), adding a second layer 1 composition (which now constitutes a third layer of the total multilayered pre-form), and so on), it is preferred to start with the disclosed layer 1 composition where recycled friction material composition 212 is used, and end at a final layer where fresh friction material 216 is used. In general, fresh friction material provides a somewhat higher brake quality, including a somewhat higher longevity. Therefore, the number, intervals, and types of layering combinations and permutations are dictated by desired brake lining thickness, quality, cost, and etc. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A method for generating friction material to form a brake lining of a drum brake system, comprising:
a recycled friction material;
a recycled fresh friction material; and
a friction lining materials;
wherein: a recycled friction material composition is generated using the recycled friction material, the recycled fresh friction material, and the friction lining materials.

2. The method for generating friction material to form a brake lining of a drum brake system as set forth in claim 1, further comprising:
pre-forming a predetermined amount of the recycled friction material composition into a pre-form, with a shape of the pre-form having varying quantities of material throughout the pre-form.

3. The method for generating friction material to form brake lining of a drum brake system as set forth in claim 1, further comprising:
adding a predetermined amount of fresh friction material composition to the pre-form, and pre-forming the combination of the pre-form and the fresh friction material compositions into a multilayer pre-form, with a shape of the multilayer pre-form having varying quantities of material throughout the multilayer pre-form.

4. The method for generating friction material to form brake lining of a drum brake system as set forth in claim 3, further comprising:
hot compression of the multilayer pre-form to induce curing and pressure to produce recycled brake lining, with varying densities having high density regions and low density regions.

5. The method for generating friction material to form brake lining of a drum brake system as set forth in claim 3, wherein:
the pre-form includes at least one uneven surface that mates with an inner surface of the added fresh friction material composition, with the inner surface forming a shape that is complementary to the uneven surface to facilitate mechanical resistance against shearing stresses experienced by the multilayer brake lining during braking process.

6. The method for generating friction material to form a brake lining of a drum brake system as set forth in claim 1, further comprising:
mixing the recycled friction material, the recycled fresh friction material, and the friction lining materials to generates the recycled friction material composition.

7. The method for generating friction material to form a brake lining of a drum brake system as set forth in claim 6, wherein:
the mixing is performed in one or more stages;
with a stage of one or more stages includes mixing for a duration a percentage of a total wt % of the recycled friction material, the recycled fresh friction material, and the compounds of the friction lining material.

8. The method for generating friction material to form a brake lining of a drum brake system as set forth in claim 7, wherein:
the stage of the one or more stages is comprised of a first, a second, and a third stage.

9. The method for generating friction material to form a brake lining of a drum brake system as set forth in claim 8, wherein:
the first stage of the one or more stages includes mixing for a first duration:
a first percentage of a total wt % of the recycled friction material;
a first percentage of a total wt % of the recycled fresh friction material; and
a first percentages of a total wt % of the compounds of the friction lining material.

10. The method for generating friction material to form a brake lining of a drum brake system as set forth in claim 8, wherein:
the second stage of the one or more stages includes mixing for a second duration:
a second percentage of a total wt % of the recycled friction material;
a second percentage of a total wt % of the recycled fresh friction material; and
a final percentages of a total wt % of the compounds of the friction lining material.

11. The method for generating friction material to form brake a lining of a drum brake system as set forth in claim 8, wherein:
the third stage of the one or more stages includes mixing for a third duration:
a third percentage of a total wt % of the recycled friction material; and
a third percentage of a total wt % of the recycled fresh friction material.

12. The method for generating friction material of a drum brake system as set forth in claim 1, wherein:
the recycled friction material is used, uncontaminated friction material from used brake linings used in drum brake systems.

13. The method for generating friction material of a drum brake system as set forth in claim 1, wherein:
the recycled fresh friction material is comprised of friction material residue generated at a finishing process of a final brake lining product that is comprised of original, non-recycled, fresh friction material.

14. The method for generating friction material of a drum brake system as set forth in claim 1, wherein:
the recycled friction material is prepared by:
crushing used, uncontaminated friction material to generate crushed recycled friction material;
granulating the crushed recycled friction material to generate recycled friction material particles of a size below a first threshold size;
buffering sufficient amounts of the recycled friction material particles for continuous recycling operation; and
separating buffered recycled frictional material particles of size below a second threshold size, constituting a finally granulated recycled frictional material particles for use in making brake linings.

15. A method for recycling brake linings of a drum brake system, comprising:
providing used, uncontaminated friction material, constituting recycled friction material;
crushing the recycled friction material to generate crushed recycled friction material;
granulating the crushed recycled friction material to generate recycled friction material particles of a size below a first threshold size;
separating recycled frictional material particles of size below the first threshold size from particles sizes below a second threshold size;
wherein: recycled frictional material particles of size below the second threshold size constitute a finally granulated recycled frictional material particles for use in making brake linings.

16. The method for recycling brake linings of a drum brake system as set forth in claim 15, further, comprising:
buffering sufficient amounts of the recycled friction material particles for continuous recycling operation.

17. The method for recycling brake linings of a drum brake system as set forth in claim 15 wherein:
the first threshold size of the recycled friction material particles is approximately 8 mm or less.

18. The method for recycling brake linings of a drum brake system as set forth in claim 15, wherein:
the second threshold size of recycled friction material particles is approximately 5 mm or less.

19. The method for recycling brake linings of a drum brake system as set forth in claim 15, wherein:
the moisture content of the recycled friction material particles is less than or equal to 10% in mass.

20. The method for recycling brake linings of a drum brake system as set forth in claim 15, wherein:
the used uncontaminated friction material is obtained by:
removing material not part of the friction material; and
discarding the friction material that is contaminated.

21. A brake lining for a drum brake system, comprising:
a first layer that includes recycled frictional material, and is pre-formed to have varying quantities of material throughout the first layer and includes at least one uneven surface;
a second layer that includes fresh frictional material that is pre-formed on top of and in combination with the pre-formed first layer to form a dual layer brake lining that has varying quantities of material throughout, with areas having greater quantities of material generating higher density regions of the dual layer brake lining slowing abrasion of lower density regions generated by areas of lesser quantities of materials, with lower density regions of the brake lining improving brake quality;
the at least one uneven surface mechanically mates with an inner surface of the second layer of the dual layer brake lining to facilitate mechanical resistance against shearing stresses experienced by the dual layer brake lining during braking process.

22. The brake lining for a drum brake system, as set forth in claim 21, wherein:
the recycled frictional material is comprised of used and worn out friction material.
